(19) United States
(12) Patent Application Publication
(10) Pub. No.: US 2014/0327673 A1
(43) Pub. Date: Nov. 6, 2014

(54) REAL-TIME GLOBAL ILLUMINATION USING PRE-COMPUTED PHOTON PATHS

(71) Applicant: CRYTEK GMBH, Frankfurt/Main (DE)

(72) Inventor: Tiago Sousa, Frankfurt (DE)

(21) Appl. No.: 13/887,266

(22) Filed: May 3, 2013

(51) Int. Cl. G06T 15/50

(52) U.S. Cl. CPC G06T 15/506
USPC 345/426

(57) ABSTRACT

A method for real-time global illumination of a computer graphics scene is described, wherein the method comprises the steps of providing a plurality of samples of a computer graphics scene, each sample including an indication of intersections of sample rays with other samples of the plurality of samples; determining, for each sample of the plurality of samples, a lighting contribution of the sample based on the indication of intersections of the sample; and calculating a global illumination of the computer graphics scene based on the lighting contributions of the samples. Furthermore, a graphics processing unit and a computing system are disclosed.

### TECHNICAL FIELD

The present disclosure relates to a method for real-time global illumination of a computer graphic scene and, in particular, to a graphics processing unit. Moreover, the disclosure relates to a computing system that may enable real-time global illumination.

### BACKGROUND

In computer graphics, high-quality global illumination represents a challenging task. In contrast to local illumination or simple point lighting models, global illumination is capable of providing an accurate and realistic rendering of a computer graphics scene in a general lighting environment. However, since general lighting environments are more complex and compelling, the computation of global illumination requires a huge amount of resources. Usually, techniques for real-time global illumination are based on approximations or simplifications of the general lighting environment. Accordingly, the quality of the resulting rendered computer graphics scene is reduced.

Real-time global illumination is typically handled using volumetric-based approaches. These require either a voxelized scene input or reflective shadow maps that define geometry albedo properties for later use in generating a light propagation volume. However, if higher quality levels are required, and if multiple light sources are present in the computer graphics scene, these techniques usually involve a high memory consumption and performance level. Furthermore, volumetric techniques are applicable to static computer graphics scenes, which include time-invariant geometry objects. If dynamic or changing geometry objects are used, a costly re-voxelization or regeneration of the reflective shadow maps as well as the light propagation volume is required.

Another group of techniques, such as spherical harmonics-based light mapping, require lengthy pre-processing stages. At run time, the geometry of the computer graphics scene must be static so that changes in reflectance properties do not affect light transport. Furthermore, any changes in scene lighting require a reprocessing of the entire affected area.

Traditional high dynamic range (HDR) light maps provide high-quality solutions, but are not real-time capable and require a lengthy pre-processing stage at least for complex scenes. Accordingly, HDR light maps impose a slow workflow in production environments where fast iterations are of major importance. It has also been proposed to update the HDR light maps after several frames, however, this clearly results in a quality trade-off. Correspondingly, any changes in scene lighting require a reprocessing of affected areas in the computer graphics scene. Other techniques, such as screen space global illumination (SSGI), rely on limited conditions, such as local light bouncing, and require additional computation resources, for example, when handling occluded regions.

### SUMMARY

According to the present disclosure, computation of high-quality global illumination of a computer graphics scene in real time is enabled. Furthermore, one or more embodiments of the present disclosure provide real-time global illumination with dynamic light sources. Still further, one or more embodiments of the present disclosure handle dynamic geometry at run time.

The present disclosure includes a description of a method for real-time global illumination of a computer graphics scene and a graphics processing unit. Furthermore, a computing system is described.

A first aspect of the present disclosure provides a method for real-time global illumination of a computer graphics scene, comprising: providing a plurality of samples of a computer graphics scene, each sample including an indication of intersections of sample rays with other samples of the plurality of samples; determining, for each sample of the plurality of samples, a lighting contribution of the sample based on the indication of intersections of the sample; and calculating a global illumination of the computer graphics scene based on the lighting contributions of the samples.

The method uses a discretization of the computer graphics scene into a plurality of samples. The samples include information about intersections of respective sample rays that are associated with the respective sample and reflect an interrelation of the respective sample with other samples of the computer graphics scene. In particular, each sample ray may model a photon path from other samples to the sample. The information about intersections, which may be preferably pre-computed, and the resulting interrelations between samples of the computer graphics scene may be used to determine, for each sample, the contribution of the sample to the global illumination of the computer graphics scene. The indication of intersections of each sample may be used to derive a lighting contribution of the respective sample, which, in combination with lighting contributions of the other samples, may be used to calculate the global illumination of the computer graphics scene.

The method, which may be a computer-implemented method, enables realistic and detailed global illumination of computer graphics scenes, which may include multiple dynamic light sources and which can handle dynamic changes of scene geometry reflectance properties in real time. The method can also handle dynamic changes of geometry objects of the computer graphics scene.

In an illustrative embodiment, the method further comprises analyzing geometry objects of the computer graphics scene and generating the plurality of samples by distributing the samples at surfaces of the geometry objects. The surfaces of the geometry objects may be defined as meshes or point clouds or using any other suitable description technique for geometry objects and primitives. The geometry objects and their surfaces may be analyzed in order to distribute the samples in the computer graphics scene. For example, the samples may be uniformly and/or randomly distributed on the surfaces of all geometry objects in the scene or may be arranged according to a set of rules, which provide for a good coverage of the surfaces of the geometry objects of the computer graphics scene based on a current focus on or view frustum of the scene. The number of samples may also be limited using a threshold in order to enable storage of the samples in a memory or buffer of a reasonable size and an efficient handling by respective processing components.

In yet another embodiment, for each sample of the plurality of samples, each sample ray is casted from the sample and intersections of the sample rays with other samples of the plurality of samples are determined. For each sample, a predetermined number of sample rays may be defined and each sample may be casted from a location or position of the sample in a different direction in order to determine intersections with other samples. For example, each sample may be represented as a sample point on a surface of a geometry object of the computer graphics scene and the sample ray may be casted from the sample point in a direction, which may be, for example, defined as angles or using quaternions or similar techniques used to define directions or orientations in 3D space.

In yet another embodiment, such determining of intersections is based on a sample radius threshold. Accordingly, each sample ray of a sample may be checked against intersections with a sphere, rectangle, or any other suitable boundary object which may be centered or otherwise arranged at another sample. For example, the other sample may be defined as a sample point on a surface of a geometry object and a sphere with a radius according to the sample radius threshold and a center at the sample point may be used to check for intersections with sample rays casted from other samples or sample points.

According to yet another embodiment, the method further comprises storing an identification of another sample of the plurality of samples in the indication of intersections if an intersection of the sample ray with the other sample has been determined. The samples may be enumerated or otherwise identified, for example, using an identification sᵢ. Correspondingly, if an intersection of a sample ray of a first sample sₘ with a second sample sₙ or its respective bounding object is determined, sₙ may be stored in the indication of intersections of the first sample sₘ.

According to an illustrative embodiment, the sample rays of each sample are distributed over a surface hemisphere at the sample. For example, the samples may be uniformly or randomly distributed over the surface hemisphere which may be arranged at a position or location of the sample. The samples may also be distributed according to a predetermined set of rules, for example, according to a reflectance distribution function of the surface at the sample. The surface hemisphere at the sample may be oriented according to a normal of the surface at the sample or may be oriented according to other parameters and criteria, which may be derived from the entire surface of the respective geometry object or according to other rules. Accordingly, the indication of intersections of sample rays may be defined as a list of photon bounce intersection points as distributed over the surface hemisphere using sample IDs of the intersected samples.

In yet another illustrative embodiment, the indication of intersections is an array, wherein one or more indices of the array denote one of the sample rays, and the entry of the array at the one or more indices indicates a sample intersected by the respective sample ray. Accordingly, the sample rays, which may be distributed over a hemisphere arranged at a location or position of the sample, may be enumerated using one or more indices. For example, the sample rays r of sample sᵤ may be enumerated using a single index i and the respective array Aᵤ may be a one-dimensional array with entries Aᵤ[i] referring to sample ray rᵢ. Similarly, the sample rays r may be enumerated using two indices i and j, and the array Aᵤ may be a two-dimensional array with entries Aᵤ[i,j] referring to sample ray r_{i,j}. Initially, the array of intersections Aᵤ may be initialized to a value, which indicates that no other samples are intersected by the sample rays r, for example, by initializing the values of the array to −1 or any other suitable value that does not interfere with an identification of a sample. Thereafter, the sample rays rᵢ may be checked iteratively or in parallel for intersections with other samples. If an intersection of a sample ray rᵢ with another sample sⱼ is determined, the respective entry of array Aᵤ may be set to Aᵤ[i]=sⱼ. Accordingly, the arrays of intersections may be used to determine potential lighting contribution affecting the current sample, which may originate from other samples intersected by one of the sample rays of the current sample. The method allows for significantly speeding up determination of influencing components by checking the samples and respective indications of intersections with other samples. For example, if array Aᵢ of sample sᵢ does not include an intersection with a sample s_{b}, an illumination component of sample s_{b} does not need to be taken into consideration when determining the lighting contribution of sample sᵢ. Hence, only lighting contributions of samples being intersected by one of the sample rays need to be taken into consideration.

In an illustrative embodiment, the method further comprises generating the plurality of samples during a pre-processing stage. This has the advantage that a computer graphics scene with geometry objects having a static surface geometry can be entirely pre-computed during pre-processing and, therefore, does not affect the computation during run time.

According to another embodiment, the method further comprises modifying one or more geometry objects of the computer graphics scene and updating the plurality of samples. If, for example, a geometry object is modified, the corresponding samples at its surface may be repositioned and reoriented to the new location of the surface of the modified geometry object, the intersections of its sample rays may be re-computed, and/or the other samples may be checked for intersections with the repositioned sample. This updating procedure can be optimized, since it is known that only the location and/or orientation of the modified sample has been changed. Therefore, only intersections related to the modified sample have to be checked, which can be computed significantly faster than updating intersections of all samples. Accordingly, dynamic geometries can be efficiently handled and global illumination of the respective computer graphics scene can be computed in real time.

In yet another embodiment, said determining of a lighting contribution for each sample includes identifying light sources affecting the sample, creating a light list based on the identified light sources, and computing the lighting contribution of the sample based on the light list. The lighting affecting each sample may be computed in order to determine the lighting contribution of the sample used for calculation of the global illumination. The light sources affecting the sample may be identified by analyzing the indication of intersections of sample rays with other samples. This analysis can be iteratively continued for a number of bounces, i.e., the intersections of a sample intersected by one of the sample rays may be further analyzed. Each light source in the computer graphics scene may therefore directly affect a sample and/or indirectly affect the sample by affecting another sample intersected by one of the sample rays. For example, if a first sample includes an indication of intersection with a second sample and if the second sample is affected by a light source, the light source may be added to the light list of the first sample. The iteration therefore approximates the light of light sources that bounces one or more times at surfaces of geometry objects of the computer graphics scene. By using the plurality of samples, the identification of affecting light sources can be greatly simplified and the computation of the global illumination can be accelerated to enable real-time computation of global illumination.

According to one embodiment, the method further comprises dividing the computer graphics scene according to one or more tiles, and, for each tile, identifying the samples affecting the tile, creating a list of the identified samples, and gathering the lighting contribution from the samples of the list to calculate the global illumination of the tile. The calculation of global illumination may be, for example, performed during deferred shading or lighting processing, preferably via clustered tiled rendering or variants. An advantage of tiled rendering is that computation may be performed in parallel on respective hardware. The samples affecting each tile may be found by maintaining a list of samples about a current camera view frustum. Furthermore, per-tile frustum culling can be performed similarly to processing of deferred light sources, such as up to 1024 threads in parallel in hardware, and a list can be generated for the current tile or thread group. The global illumination may be computed by gathering the lighting contributions from all samples affecting the respective tile.

In yet another embodiment, said determining of a lighting contribution for each sample and said calculating of a global illumination is performed during run time. Accordingly, the global illumination enabling realistic rendering of the computer graphics scene may be computed in real time. The term “real-time,” according to the present disclosure, may refer to processing wherein the results of the computation are provided within a negligible or very small amount of time which, for a user or viewer, does not appear to affect the display and/or further processing, such as an interaction with the computer graphics scene. Accordingly, real-time global illumination may be computed fast enough to provide for interactive frame rates, such as at least 15, 30, 45, and/or 60 frames per second, preferably between 30 and 120 frames per second, and most preferably at 60 frames per second. Accordingly, the computation of the global illumination for each frame may be computed in 60 ms or less, preferably in 16 ms or less. Preferably, to be usable in a real-time context, such as in video games, a frame may have an overall processing time budget of 33 ms, with lighting (including global illumination) having a processing time budget of up to 16 ms.

In an illustrative embodiment, one or more processing steps of the method are mapped on GPGPU functionality. The abbreviation GPGPU generally refers to a general-purpose graphics processing unit, which represents a graphics processing unit with extended functionality. In particular, a GPGPU may include an interface, such as the DirectX 11 (or “DX11”) DirectCompute API, available from Microsoft Corporation, which may enable the use of dedicated resources and functionality of the graphics processing unit for general processing and computational tasks, such as parallel computations, exploiting the high-throughput capabilities with data parallelism. For example, the step of analyzing the geometry objects of the computer graphics scene and randomly generating the plurality of samples at a geometry surface may be achieved using scene voxelization or by generating sampling points on a triangle mesh surface, which may be directly mapped on GPGPU functionality. Furthermore, said determining of lighting contributions of samples based on the indication of intersections of each sample may be performed via GPGPU functionality, which may be used to compute the lighting affecting each sample. Also, the processing of the one or more tiles can be mapped on GPGPU functionality. Furthermore, it is to be understood that any other processing step performed during pre-processing or at run time can be mapped on GPGPU functionality.

In yet another embodiment of the present disclosure, the plurality of samples is provided as a list of samples in a geometry buffer. The entire geometry of the computer graphics scene may be discretized into a coarse world geometry-buffer representation or point cloud representation. The buffer may essentially include a list of the samples representing the world geometry.

In yet another embodiment, each sample further includes one or more of a position of the sample, a surface normal at the sample, a surface diffuse albedo at the sample, and an indication of a material of a geometry surface at the sample. The surface normal as well as the position may be defined using world coordinates as a world space surface normal and a world space position, respectively. The indication of a material may include the material ID of the respective geometry and/or further material properties.

In a further embodiment, the method further comprises rendering the computer graphics scene using the global illumination.

According to another aspect of the present disclosure, a graphics processing unit is provided, comprising an input circuitry configured to receive a representation of a computer graphics scene and a plurality of samples of the computer graphics scene, each sample including an indication of intersections of sample rays with other samples of the plurality of samples. The graphics processing unit further comprises an output circuitry which is configured to deliver a global illumination of the computer graphics scene, and a processing unit configured to determine, for each sample of the plurality of samples, a lighting contribution of the sample based on the indication of intersections of the sample, and calculate the global illumination of the computer graphics scene based on the lighting contributions of the samples.

The graphics processing unit allows for a real-time computation of a global illumination of the computer graphics scene based on a discretization of the geometry of the computer graphics scene. It further allows for a dynamic change of one or more light sources of the scene as well as a dynamic change of scene geometry reflectance properties. Furthermore, it allows for handling of dynamic geometry.

In an illustrative embodiment, the plurality of samples are distributed on surfaces of geometry objects of the computer graphics scene.

According to another embodiment, the indication of intersections of each sample stores one or more identifications of other samples of the plurality of samples that are each intersected by a sample ray casted from the sample.

According to yet another embodiment, the intersections are constrained by sample radius thresholds. Accordingly, a sample ray may intersect with another sample if the sample ray hits a bounding volume associated with the other sample, wherein the dimensions of the bounding volume are based on the sample radius threshold value. For example, the bounding volume may be a sphere around the sample with a radius corresponding to the sample radius threshold.

In an illustrative embodiment, the processing unit is further configured to generate a plurality of samples during a pre-processing stage.

According to another embodiment, the input circuitry is further configured to receive a modification of one or more geometry objects of a computer graphics scene, and the processing unit is further configured to update the plurality of samples.

According to an illustrative embodiment, in order to determine the lighting contribution for each sample, the processing unit is further configured to identify light sources affecting the sample, create a light list based on the identified light sources, and compute the lighting contribution of the sample based on the light list.

In yet another embodiment, the processing unit is further configured to divide the computer graphics scene according to one or more tiles and, for each tile, identify the samples affecting the tile, create a list of the identified samples, and gather the lighting contribution from the samples of the list to calculate the global illumination of the tile.

In an illustrative embodiment, the graphics processing unit is a general-purpose graphics processing unit (GPGPU).

In one embodiment, the processing unit is further configured to render the computer graphics scene using the global illumination in real time.

According to another aspect of the present disclosure, a computing system is provided comprising a central processing unit, a memory, a graphics processing unit connected to the central processing unit and the memory, and a graphics output. The memory stores a representation of a computer graphics scene and a plurality of samples of the computer graphics scene, each sample including an indication of intersections of sample rays with other samples of the plurality of samples. The graphics processing unit is configured to receive the representation of the computer graphics scene and the plurality of samples of the computer graphics scene and further to determine, for each sample of the plurality of samples, a lighting contribution of the sample based on the indication of intersections of the sample; calculate a global illumination of the computer graphics scene based on the lighting contribution of the samples in real time; and render the computer graphics scene based on the global illumination. The rendered computer graphics scene is provided via the graphics output.

It is to be understood that the graphics processing unit of the computing system, according to embodiments of the present disclosure, may include features of and/or may be configured according to other embodiments of the present disclosure. In particular, the graphics processing unit may be a graphics processing unit according to another embodiment of the present disclosure, such as a general-purpose graphics processing unit enabling a mapping of processing steps according to embodiments of the present disclosure to GPGPU functionality.

Furthermore, it is to be understood that respective processing steps may either be performed by the central processing unit and/or by the graphics processing unit during pre-processing or at run time. For example, the computer graphics scene may be voxelized either using the graphics processing unit or the central processing unit. In addition, lighting affecting the samples may be computed by either the graphics processing unit or the central processing unit. The use of the central processing unit may enable the use of older platforms while preserving interactive frame rates.

According to yet another aspect of the present disclosure, a computer-readable medium having instructions stored thereon is provided, wherein said instructions, in response to execution by a computing device, cause said computing device to automatically perform a method according to embodiments of the present disclosure.

### DESCRIPTION OF THE DRAWINGS

The specific features, aspects, and advantages of the present disclosure will be better understood with regard to the following description and accompanying drawings where:

FIG. 1 shows a schematic representation of a sample and respective sample rays on a geometry surface according to one embodiment of the present disclosure;

FIGS. 2A and 2B show schematic views on a plurality of samples and intersections of respective sample rays according to embodiments of the present disclosure;

FIG. 3 shows a flow chart of a method according to one embodiment of the present disclosure; and

FIG. 4 shows a flow chart of a method according to an embodiment of the present disclosure.

### DETAILED DESCRIPTION

In the following description, references are made to drawings which show, by way of illustration, various embodiments. Also, various embodiments will be described below by referring to several examples. It is to be understood that the embodiments may include changes in design and structure without departing from the scope of the claimed subject matter.

Global illumination refers to a technique used in computer graphics which enables realistic rendering of computer graphics scenes. The high degree of realism is achieved by better reflecting the light transport within the computer graphics scene. Yet, since global illumination requires complex computations, it is difficult to compute global illumination in real time without sacrificing rendering quality. Generally, the rendering of a computer graphics scene takes the geometry objects, their materials, and the light sources of a computer graphics scene and produces an image. In order to determine how much light is reflected from each point or geometry surface of the computer graphics scene to the viewer, the influence of light sources on respective geometry objects and their material properties are analyzed. This influence may be formulated using a rendering equation, which for each point x and direction ωᵣ defines the amount of light emitted from point x in combination with light reflected at point x. In particular, given geometry objects illuminated in the computer graphics scene by one or more light sources, the rendering equation models the equilibrium of the flow of light in the scene. It can be used to determine how a visible point reflects light towards a viewer. The rendering equation may be formulated as:

L(x,ωᵣ)=Lₑ(x,ωᵣ)+∫_{Ω}_{⁺}ƒᵣ(ωᵢ,x,ωᵣ)Lᵢ(x,ωᵢ)cos θᵢdωᵢ

In the rendering equation, the term L(x,ωᵣ) defines the radiance leaving point x on a geometry object in a given direction ωᵣ, wherein radiance defines the intensity of light from a point to a certain direction. The radiance L(x, ωᵣ) is a sum of radiance Lₑ (x, ωᵣ) directly emitted from x in the given direction ωᵣ and an integral over the hemisphere of point x of incident light Lᵢ(x, ωᵢ) weighted by reflectance distribution and material properties of the surface at point x, represented by a function ƒᵣ (ωᵢ, x, ωᵣ), also referred to as a bidirectional reflectance distribution function (BRDF). The BRDF may be a 4D function that models the percentage of light from direction ωᵢ leaving point x in direction ωᵣ.

In order to compute the global illumination, the rendering equation may be approximated. According to an example, the rendering equation may be approximated based on a plurality of interrelated samples that represent a discretized world geometry and define sample photon paths in the computer graphics scene. The approximation enables dynamic high-quality lighting with pre-computed photon paths represented through intersections of sample rays between the samples of the discretized world geometry.

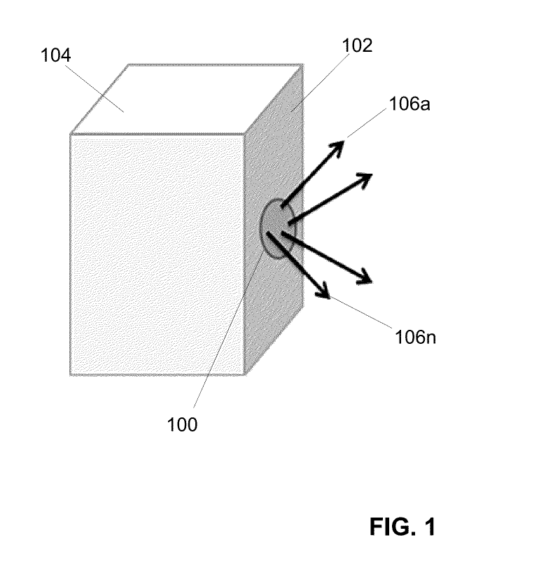

FIG. 1 shows a sample according to one embodiment of the present disclosure. The sample 100 may be located at a surface of a geometry object, such as on a side 102 of a box 104. The sample 100 may contain or include references to a normal of the surface of the side 102, which may be represented in local coordinates of the geometry object or preferably in world coordinates. Furthermore, the sample 100 may include an indication of a diffuse albedo of the surface at the sample location, a material ID, a position of the sample location in local or world coordinates, as well as a list of photon bounce intersections, as indicated by sample rays 106a-106n. The sample rays 106a-106n may be distributed over a surface hemisphere at the sample 100. The sample 100 may be represented in a coarse world geometry buffer (G-buffer), and the list of photon bounce intersections of the sample 100 may include IDs of other samples intersected by one of the sample rays 106a-106n in the G-buffer list.

A sample could be stored in the G-buffer list according to the following pseudo-code structure:

struct SWorldSample
{

| | |
|---|---|
| float2 vPosition; | // 16 bits per xyz component. 16 bits matID |
| uint nSamples[16]; | // 16 bits per sample |
| uint nProperties; | // 16 bits: Normal.xy,packed z sign. 16bits: albedo |

};

It is to be understood that based on the desired quality, the number of samples and the number of sample rays can be varied. As an example, using the above structure, approximately 65,536 samples can be stored at a cost of approximately 4.75 MB.

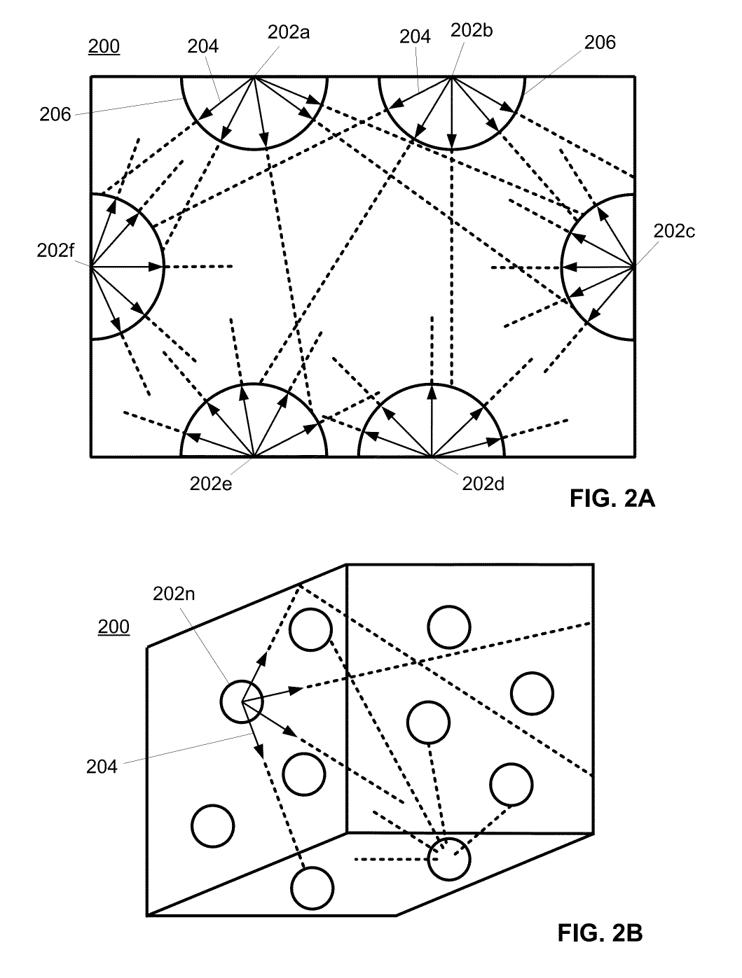

FIGS. 2A and 2B show a schematic view on a plurality of samples in a 2D and 3D space, respectively, according to embodiments of the present disclosure. The computer graphics scene 200 may include a plurality of samples 202a-202n, which may be placed on surfaces of geometry objects in the computer graphics scene 200. Even though only margin surfaces of a box are shown in FIGS. 2A and 2B, it is to be understood that further and other geometry objects may be included in the computer graphics scene 200, and the samples 202a-202n may be distributed at surfaces of these geometry objects accordingly.

In order to compute the samples, all world geometry of the computer graphics scene 200 may be processed and the samples 202a-202n may be randomly distributed at the geometry surface of the world geometry. The samples 202a-202n may be configured according to the sample 100 shown in FIG. 1 and may, in particular, include a list of photon bounce intersections, which may be represented as sample rays 204. The samples 202a-202n may be generated via a graphics processing unit or a central processing unit using scene voxelization or generating sampling points on a triangle mesh surface during a pre-processing stage. The samples 202a-202n may also be updated at run time if dynamic geometry is supported, wherein the results may be preferably cached.

For each sample 202a-202n, a pre-defined number of sample rays 204 may be casted from a position of the respective sample 202a-202n, and for each intersection with any of the other world samples 202a-202n, the corresponding sample ID of the hit may be stored. The intersections may further be determined based on a given sample radius threshold as indicated by spheres 206 around samples 202a-202n. Preferably, the sample rays 204 may be enumerated according to a list or array of photon bounce intersections, wherein the corresponding entry in the list or array may include the ID of the sample that may be hit or intersected by the respective sample ray 206. As shown in FIG. 2A, the list of photon bounce intersections of sample 202a may include the IDs of sample 202c, 202e, and 202f, which are intersected by respective sample rays 204. For example, if the sample rays 204 in samples 202a-202f are assigned the indices 1 to 5 clockwise, starting at a local left-hand side corner, and if the respective samples 202a-202f are associated with IDs 1 to 6, respectively, the list of photon bounce intersections of sample 202a could be defined as (3, 3, 5, 6, 6). Similarly, the list of photon bounce intersections of sample 202b may include the following entries (#, 3, 4, 5, 6), wherein # represents no hit or intersection of the respective sample ray.

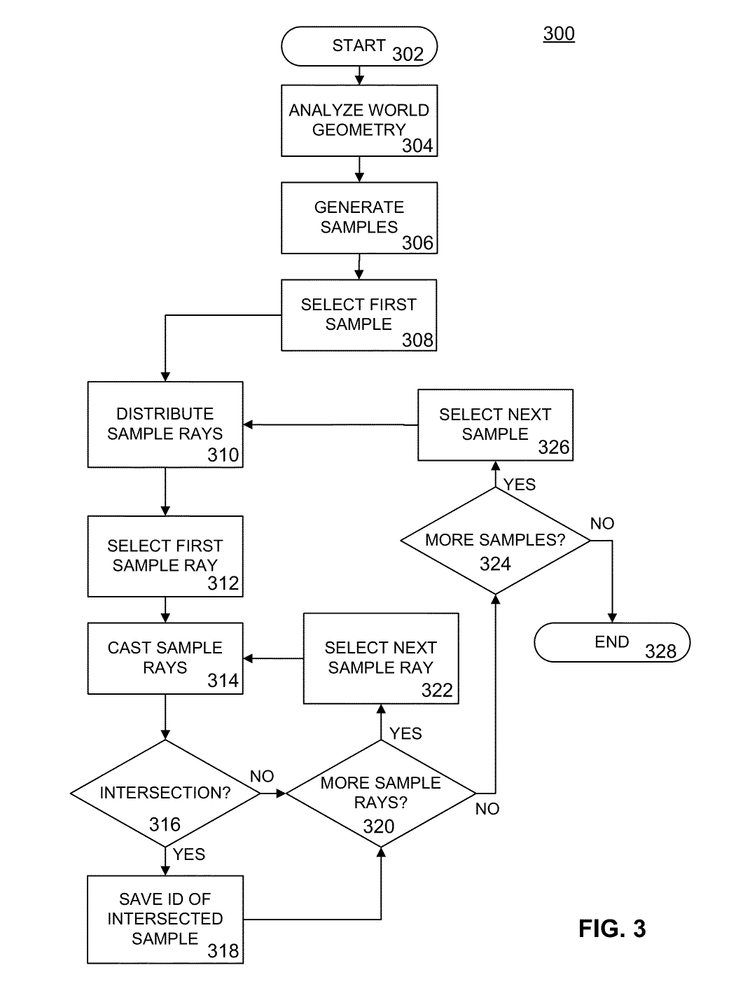

FIG. 3 shows a flow chart of a method according to one embodiment of the present disclosure that may be performed in a pre-processing stage and that may result in pre-computed photon paths related to samples of a computer graphics scene, such as the samples 100 and 202 shown in FIGS. 1 and 2A, respectively. The method 300 may begin at step 302. The world geometry of the computer graphics scene may be analyzed in step 304 and a pre-determined number of samples may be generated and uniformly or randomly distributed on respective surfaces of the world geometry in step 306.

The iterative processing may thereafter begin in step 308, wherein a first sample may be selected. For the selected sample, a pre-determined number of sample rays may be uniformly or randomly distributed on a surface hemisphere at the sample in step 310. Thereafter, a next iterative processing may begin, wherein a first sample ray may be selected in step 312 and casted from the location of the sample into the computer graphics scene according to its orientation in step 314. The casted ray may be checked for intersections with other samples of the computer graphics scene in step 316. If an intersection with another sample is found, the ID of the intersected sample may be stored in a respective structure of the sample in step 318. If no intersection is found, or after storing the ID in step 318, the sample rays may be analyzed and it may be determined if there are further sample rays that still have not been processed in step 320. If there are unprocessed sample rays left, the next sample ray may be selected in step 322 and the processing according to steps 314 to 320 may be repeated with the next selected sample ray.

If all sample rays have been processed, the pre-processing of the respective sample may be finished and the method may proceed with step 324, wherein it may be determined if there are further unprocessed samples. If there are unprocessed samples left, a next unprocessed sample may be selected in step 326, and the processing according to steps 310 to 324 may be repeated with the next selected sample. If all samples have been processed, the pre-processing may end in step 328.

Even though method 300 has been described in a certain order according to steps 302 to 328, it is to be understood that particular processing steps may be omitted and further processing steps may be added without departing from the subject matter of the present disclosure. Also, the processing steps may be performed sequentially, in parallel, and/or in another sequence than shown in FIG. 3. For example, the sample rays may be equally distributed in each sample in parallel, and, thereafter, the sample rays may be analyzed for each sample iteratively. Similarly, the determination of intersections and the computation of the photon paths may be computed in parallel for groups of samples using GPGPU parallelism.

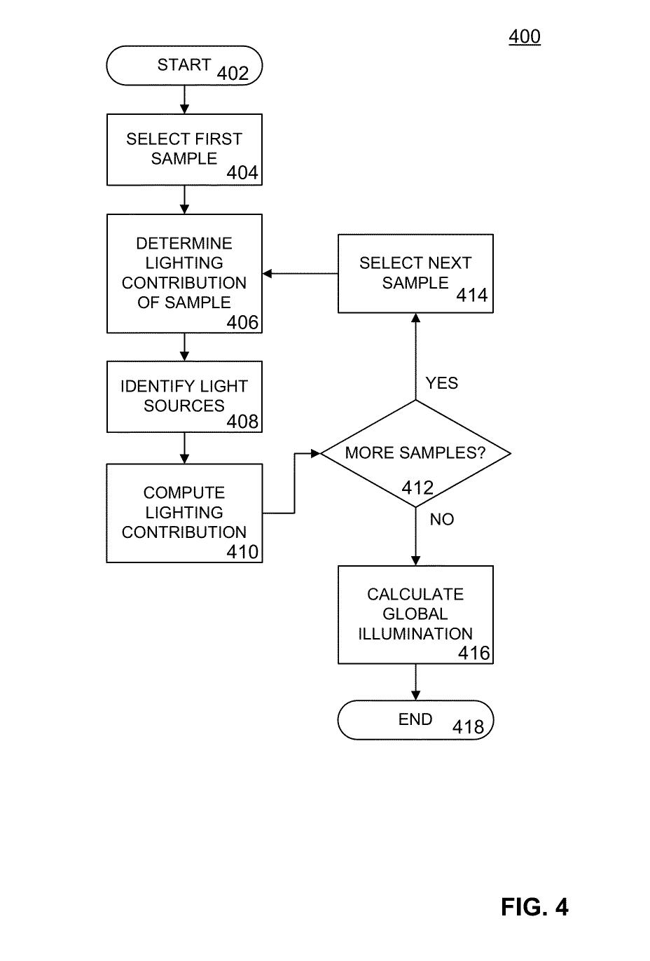

FIG. 4 shows a method performed at run time for computation of a global illumination of a computer graphics scene according to one embodiment of the present disclosure. The method 400 may start in step 402 after a plurality of samples of a computer graphics scene have been computed and provided, such as by executing the method 300 as shown in FIG. 3. The method 400 may be called with a reference or a link to data of the computer graphics scene and the plurality of samples of the computer graphics scene as input parameters, wherein each sample may include an indication of intersections of sample rays with other samples of the plurality of samples. An iterative processing may begin at step 404, wherein a first sample may be selected. In step 406, a lighting contribution of the selected sample may be determined by computing the lighting affecting the sample. This computing may be preferably done via GPGPU functionality. The computation may be done by finding and/or identifying light sources that affect the sample in step 408, preferably by using the samples and the indications of intersections. Furthermore, a light list may be created based on the identified light sources. In step 410, the lighting contribution of the respective sample may be computed and it may be further determined if there are still unprocessed samples in step 412. If there are unprocessed samples, a next sample may be selected in step 414 and the processing of steps 406 to 412 may be repeated.

If all samples have been processed, a further step 416 may be performed during deferred shading or lighting processing. This could be preferably done via tiled rendering using GPGPU functionality. The respective processing may include finding all samples that affect the current tile or thread group and creating a respective sample list. This may be achieved, for example, by maintaining a list of samples about a current camera view frustum. Per-tile frustum culling can be performed and a list may be generated for a current tile. Thereafter, the lighting contribution from the samples may be gathered and used for computation of the global illumination in real time. In particular, for each fragment, the affected samples may be identified and based on the pre-computed photon paths as defined by the indications of intersections, and the contribution of respective light sources may be computed. After computation of the global illumination in step 416, the method 400 may end in step 418.

It is to be noted that steps 408 and 410 can also be mapped into a CPU instead of a GPU such that platforms with older graphics hardware also can be used to execute the method 400. If extra vertex color stream or 2D surface parameterization is available, then results from such computation can also be cached or stored for cost amortization or fixed costs. It is to be noted that memory consumption may depend on the size of the computer graphics scene, i.e., the number of geometry objects, light sources, and further parameters in the computer graphics scene, and the strategy for distributing the samples can be adjusted to the size of the computer graphics scene as well as to the available computational resources.

Even though method 400 has been described in a certain order, it is to be understood that particular processing steps may be omitted and further processing steps may be added without departing from the subject matter of the present disclosure. Also, the processing steps may be performed sequentially, in parallel, and/or in another sequence than shown in FIG. 4. For example, the lighting contribution for a plurality of samples can be determined in parallel.

While some embodiments have been described in detail, it is to be understood that aspects of the disclosure can take many forms. In particular, the claimed subject matter may be practiced or implemented differently from the examples described, and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A method for real-time global illumination of a computer graphics scene, comprising:
providing a plurality of samples of a computer graphics scene, each sample including an indication of intersections of sample rays with other samples of the plurality of samples;
determining, for each sample of the plurality of samples, a lighting contribution of the sample based on the indication of intersections of the sample; and
calculating a global illumination of the computer graphics scene based on the lighting contributions of the samples.

2. The method according to claim 1, further comprising:
analyzing geometry objects of the computer graphics scene; and
generating the plurality of samples by distributing the samples at surfaces of the geometry objects.

3. The method according to claim 1, further comprising, for each sample of the plurality of samples:
casting each sample ray from the sample; and
determining intersections of the sample rays with other samples of the plurality of samples.

4. The method according to claim 3, further comprising storing an identification of another sample of the plurality of samples in the indication of intersections if an intersection of the sample ray with the other sample has been determined.

5. The method according to claim 1, wherein the sample rays of each sample are distributed over a surface hemisphere at the sample.

6. The method according to claim 1, wherein the indication of intersections is an array, wherein one or more indices of the array denote one of the sample rays, and wherein the entry of the array at the one or more indices indicates a sample intersected by the respective sample ray.

7. The method according to claim 1, further comprising generating the plurality of samples during a pre-processing stage.

8. The method according to claim 1, further comprising:
modifying one or more geometry objects of the computer graphics scene; and
updating the plurality of samples.

9. The method according to claim 1, wherein said determining of a lighting contribution for each sample includes:
identifying light sources affecting the sample;
creating a light list based on the identified light sources; and
computing the lighting contribution of the sample based on the light list.

10. The method according to claim 1, further comprising:
dividing the computer graphics scene according to one or more tiles; and
for each tile:
identifying the samples affecting the tile;
creating a list of the identified samples; and
gathering the lighting contribution from the samples of the list to calculate the global illumination of the tile.

11. The method according to claim 1, wherein said determining of a lighting contribution for each sample and said calculating a global illumination are performed during run time.

12. The method according to claim 1, further comprising rendering the computer graphics scene using the global illumination.

13. A graphics processing unit, comprising:
an input circuitry configured to receive a representation of a computer graphics scene and a plurality of samples of the computer graphics scene, each sample including an indication of intersections of sample rays with other samples of the plurality of samples;
a processing unit configured to:
determine, for each sample of the plurality of samples, a lighting contribution of the sample based on the indication of intersections of the sample; and
calculate a global illumination of the computer graphics scene based on the lighting contributions of the samples; and
an output circuitry configured to deliver the global illumination of the computer graphics scene.

14. The graphics processing unit according to claim 13, wherein the plurality of samples are distributed on surfaces of geometry objects of the computer graphics scene.

15. The graphics processing unit according to claim 14, wherein the intersections are constrained by a sample radius threshold.

16. The graphics processing unit according to claim 13, wherein the input circuitry is further configured to receive a modification of one or more geometry objects of the computer graphics scene, and wherein the processing unit is further configured to update the plurality of samples.

17. The graphics processing unit according to claim 13, wherein, in order to determine the lighting contribution for each sample, the processing unit is further configured to:
identify light sources affecting the sample;
create a light list based on the identified light sources; and
compute the lighting contribution of the sample based on the light list.

18. The graphics processing unit according to claim 13, wherein the graphics processing unit is a general-purpose graphics processing unit.

19. The graphics processing unit according to claim 13, wherein the plurality of samples is provided as a list of samples in a geometry buffer.

20. The graphics processing unit according to claim 13, wherein each sample further includes one or more of a position of the sample, a surface normal at the sample, a surface diffuse albedo at the sample, and an indication of a material of a geometry surface at the sample.

21. A computing system, comprising:
a central processing unit;
a memory having stored therein a representation of a computer graphics scene and a plurality of samples of the computer graphics scene, each sample including an indication of intersections of sample rays with other samples of the plurality of samples;
a graphics processing unit connected to the central processing unit and the memory to receive the representation of the computer graphics scene and the plurality of samples of the computer graphics scene, wherein the graphics processing unit is configured to:
determine, for each sample of the plurality of samples, a lighting contribution of the sample based on the indication of intersections of the sample;
calculate a global illumination of the computer graphics scene based on the lighting contributions of the samples in real time; and
render the computer graphics scene based on the global illumination; and
a graphics output configured to provide the rendered computer graphics scene.
